(19) United States
(12) Patent Application Publication
(10) Pub. No.: US 2003/0121496 A1
(43) Pub. Date: Jul. 3, 2003

(54) Engine control

(76) Inventor: Sylvain Matte, Brompton (CA)

Correspondence Address: PILLSBURY WINTHROP, LLP, P.O. BOX 10500, MCLEAN, VA, 22102, US

(21) Appl. No.: 10/320,376

(22) Filed: Dec. 17, 2002

Related U.S. Application Data
(60) Provisional application No. 60/344,052, filed on Jan. 3, 2002.

(51) Int. Cl. F02D 1/00

(52) U.S. Cl. 123/331

(57) ABSTRACT

An engine control system utilizes the brake specific fuel consumption (BSFC) to increase the temperature of the exhaust gas present in the exhaust pipe and determines a moving average engine speed from at least two actual engine speeds determined from a speed sensor located on the crankshaft of the engine. The control system also includes a map that uses the moving average engine speed and the actual engine speed to retrieve a solenoid duty cycle to alter the BSFC of the engine at certain RPM to increase the maximum power output of the engine.

### CROSS-REFERENCE TO RELATED APPLICATIONS

This application claims the benefit of priority to U.S. application Ser. No. 60/344,052, filed Jan. 3, 2002, the contents of which are herein incorporated by reference.

### FIELD OF THE INVENTION

The present invention relates to an engine control system that enables an engine to obtain an increased power output during high RPM and low exhaust pipe temperature operation by modifying the brake specific fuel consumption (BSFC) of the engine.

### BACKGROUND OF THE INVENTION

Maximum power output of an engine can be achieved by determining the optimal operation of several different engine parameters. For example, maximum power output of an engine could be obtained by determining the optimal ignition angle for a specific air/fuel ratio and a specific fuel octane level at a specific exhaust temperature found in the exhaust pipe of the engine. Operation of the engine at these parameters will produce the maximum power output as long as any one of the parameters does not change. As the engine runs and the temperature in the exhaust pipe changes, for example, the fixed parameters may no longer, produce the maximum power output of the engine at the required range of RPM operation.

All engines operate according to a power curve that is expressed as a function of the engine's speed, which is measured in revolutions per minute (or RPMs). FIG. 2 illustrates one example of such a power vs. RPM curve. As shown, a first curve 12 indicates the power vs. RPM of an engine while the temperature in the exhaust pipe is low, i.e. approximately 100 ° C. A second curve 14 indicates the power vs. RPM of the same engine when the temperature in the exhaust pipe has increased to approximately 500° C. As can be seen by curve 12, the slope of a curve corresponding to low exhaust pipe temperature and high RPM operation (i.e. 7000-9000 RPM) decreases sharply for a small increase in RPM. However, the slope of curve 14, corresponding to a high exhaust pipe temperature and high RPM operation, is much less pronounced. It can also be seen that the peak power output of an engine while operating on the high temperature curve 14 is higher than operation on the low temperature curve 12. What can be seen from curves 12 and 14 is that, during start up of the engine when the temperature of exhaust pipe is cold, peak power occurs at a lower engine RPM and drops off faster than when the temperature of the exhaust pipe is high.

In a two-stroke engine, the temperature of the exhaust gas in the exhaust or tuned pipe will have a significant effect on the performance and the power output of the engine. In a two-stroke engine, the power stroke opens the exhaust port and, due to the high pressure created in the cylinder, forces the burnt mixture into the exhaust pipe. During the power stroke, a fresh charge of air/fuel is forced through a transfer port from the crankcase into the cylinder to be compressed as the piston returns toward top dead center.

The function and shape of the tuned pipe on a two-stroke engine is selected to create negative and positive pressure waves within the tuned pipe. As a general rule, the tuned pipe has the shape of a diverging cone or a diffuser. Upon opening of the exhaust ports, a positive pressure wave begins to travel through the tuned pipe. A short distance downstream of the exhaust port. The positive wave is partially converted into a negative pressure wave by the diffuser to help increase the speed at which the burnt mixture is expelled from the cylinder into the tuned pipe. Due to the negative pressure wave, some of the fresh air/fuel mixture pushed into the cylinder through the transfer port may be sucked into the tuned pipe. In order to prevent this fresh air/fuel mixture being expelled to the atmosphere, the tuned pipe includes a converging portion downstream from the diffuser that reflects the remaining portion of the positive wave back towards the exhaust port. Due to the fundamental laws of acoustics, a positive pressure wave will be reflected as a positive pressure wave upon reaching the end of a closed pipe. The tuned pipe, being constructed such that the end opened to the atmosphere is very small, acts as a closed pipe to the pressure wave, thus reflecting the positive pressure wave in the direction of the exhaust port forcing any fresh air/fuel mixture sucked into the tuned pipe by the negative pressure wave back into the cylinder. How well this is performed within the engine is known as the engine trapping efficiency (ETE).

A tuned pipe is tuned to a short band of frequencies through its length and geometry, the frequency band corresponding to a specific range of engine RPM. Thus, in order to achieve maximum power, the engine operating parameters must match those frequencies to which the tuned pipe is tuned. The pressure wave created inside the tuned pipe travels at the speed of sound during engine operation. It is well known that the speed of sound increases as the temperature in the medium of which it is travelling increases. Therefore, in order to decrease the amount of time the pressure wave requires to return to the exhaust port of the engine, the temperature inside the tuned pipe has to be increased.

In certain vehicles the power demand on the engine can be very high while the exhaust temperature in exhaust pipe is very low. An example of this can be found during a snow-cross race involving snowmobiles. At the start of the race, the racers line up and compete at the starting signal to gain the lead. Once the engine has been in operation at high RPM for some time, the exhaust pipe temperature will increase, and the engine will operate at its maximum power output for the given air/fuel ratio and other calibrated parameters. Since the tuned pipe will be hot for most of the race, the engine parameters, as well as the tuned pipe, have been calibrated to a band of high RPM operation in order to achieve maximum power output throughout the majority of the race. One set back at the beginning of the race is the cold tuned pipe. As explained earlier, the temperature of the tuned pipe, thus the temperature of the gas inside the tuned pipe, effects the speed of sound within the tuned pipe and thus the speed at which the pressure waves travel. The temperature, thus the speed of sound, inside the tuned pipe at the beginning of a race is not aligned with the optimal operating characteristics of the engine at operating speed. As a result, engine operation is outside the range for which the tuned pipe is tuned when the race begins. Therefore, when the operator wishes to increases the speed of the vehicle by increasing engine RPM, the tuned pipe is un-tuned with respect to the exhaust pipe temperature, and the engine will not produce maximum power output until the temperature increases to that which the tuned pipe is tuned.

One known method of increasing the temperature of the exhaust gas present in the tuned pipe is to retard the ignition timing of the engine. Retarding the ignition by igniting the fuel mixture after its optimal ignition point causes a reduction in the thermal efficiency, producing a higher exhaust gas temperature. Although this procedure results in a higher exhaust gas temperature during early engine operation, thus increasing the speed of sound in the tuned pipe, it requires the engine to operate at non-optimal operating conditions during the normal course of the engine operation once the exhaust gas temperature in the tuned pipe has reached a maximum.

An example of a control system, which modifies engine parameters during operation, can be found in U.S. Pat. No. 6,237,566. The '566 patent describes an engine control system that modifies the ignition timing angle to a corresponding engine speed and exhaust temperature found in the exhaust pipe of a two stroke engine. The system uses several sensors to determine the particular engine parameters around the engine and a controller to control the ignition timing depending on the output from the sensors. This permits the ignition timing to be set at the optimal position any time during engine operation.

### SUMMARY OF THE PRESENT INVENTION

In view of the foregoing, one aspect of the present invention is to provide an engine control system that increases the temperature of the exhaust gas exiting into an exhaust pipe, during high RPM and low exhaust pipe temperature, without reducing the engine's performance during normal operation.

Another aspect of the present invention is to provide an engine control system that determines an engine speed and an exhaust gas or exhaust pipe temperature to modify the air/fuel ratio and increase the power output of the engine.

Yet another aspect of the present invention is to provide an engine map that accepts engine speed and exhaust gas or exhaust pipe temperature as inputs and presents fuel flow as an output.

Another aspect of the present invention is to provide a speed sensor disposed near a rotating shaft and a temperature sensor disposed near an exhaust pipe of the engine.

Another aspect of the present invention is to provide an electronic control unit (ECU) to record the engine speed and the exhaust gas or exhaust pipe temperature and obtain from the engine map the optimum fuel flow that result in an increase in power output.

Another aspect of the present invention is to provide a solenoid disposed near the engine such that the solenoid alters the fuel flow to control the amount of fuel entering the engine.

Yet another aspect of the present invention is to provide a solenoid having a duty cycle, the duty cycle being the output of the map of the engine speed and the exhaust gas temperature.

Yet another aspect of the present invention is to provide a method of operating an engine including determining an engine speed, determining an exhaust gas or exhaust pipe temperature, determining an optimum operation of a fuel injection system from the map corresponding to the determined engine speed and exhaust gas or exhaust pipe temperature by the ECU, and operating the fuel injection system at the corresponding optimum operation to obtain an increase in power output.

Another aspect of the present invention is to provide an engine control system, capable of altering the engine power output by using only the engine speed as an input parameter.

Yet another aspect of the present invention is to determine a moving average engine speed (MAES) from the determined engine speed, the MAES being an average of at least two determined engine speeds.

Another aspect of the present invention is to provide a data map that includes an engine speed and a moving average engine speed as inputs and the operation of a fuel injection system as an output.

Another aspect of the present invention is to provide a method of operating an engine including, determining an engine speed, calculating a moving average engine speed, obtaining from the map the duty cycle of a solenoid, and operating the solenoid at the determined duty cycle operation to alter the fuel flow to the engine such that the power output of the engine will be increased.

Other aspects of the present invention will be made apparent from the description that follows.

### BRIEF DESCRIPTION OF THE DRAWINGS

The details of the present invention are described in connection with the drawings, in which:

FIG. 1 shows a two-stroke engine equipped with the engine control system of the present invention;

FIG. 2 is a graph expressing the power vs. RPM curves for two exhaust pipe temperatures;

FIG. 3 is a graph expressing the correlation between a detected exhaust pipe temperature and the moving average engine speed detected over an increase in the engine's actual RPM;

FIG. 4 is a map representing the duty cycle of a solenoid corresponding to the engine's actual RPM and the MAES;

FIG. 5 is a map representing the duty cycle of a solenoid corresponding to the engine's actual RPM and the exhaust gas or exhaust pipe temperature; and

FIG. 6 is an exploded view of a carburetor modified to function in accordance with the teachings of the present invention.

### DETAILED DESCRIPTION OF PREFERRED EMBODIMENTS OF THE INVENTION

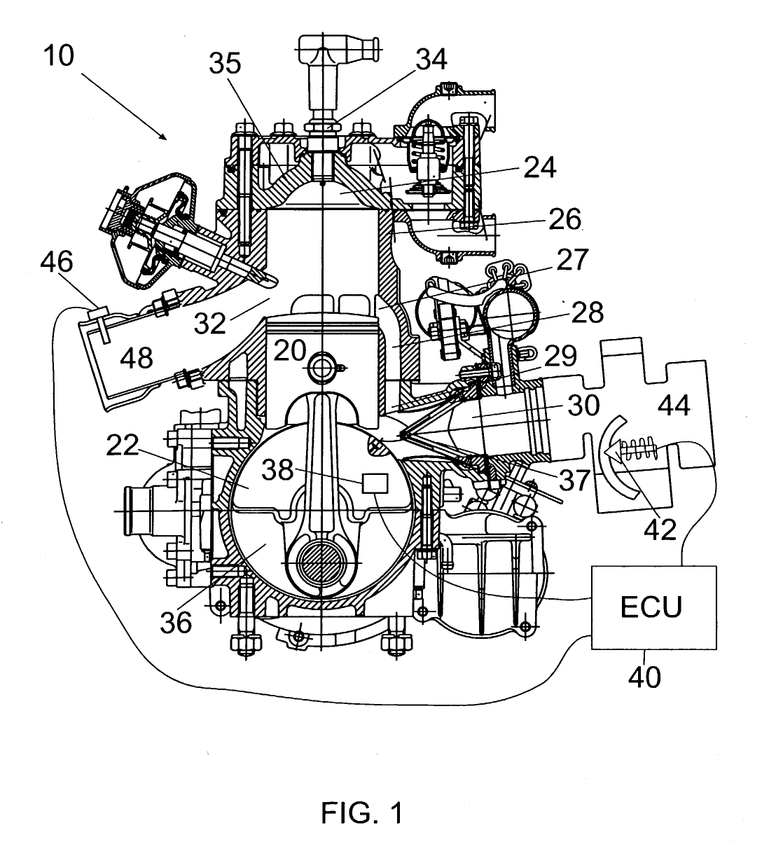

Referring to FIG. 1, a two-stroke engine 10 includes a piston 20 connected to a crankshaft 22. Piston 20 reciprocates inside a cylinder wall 26 of the engine 10. A cylinder 24 is formed between the cylinder wall 26 and the cylinder head 35. A transfer port 28, connecting the cylinder 24 to the crankcase 36, passes through the cylinder wall 26. The transfer port 28 has a first opening 27 in the cylinder 24 and a second opening 29 in the crankcase 36. The cylinder wall 26 also has an opening 32 to the atmosphere forming the exhaust port of the engine 10. An air/fuel inlet 30 enters into the crankcase chamber 36 passing through a reed valve 37 wherein the air/fuel mixture is drawn into the chamber 36 by the vacuum created in the chamber 36 when the piston 20 is traveling upward toward the spark plug 34 (or, alternatively, a plurality of spark plugs). The reed valve 37 prevents the air/fuel mixture from exiting the crankcase chamber 36 while the piston 20 is traveling away from the spark plug 34, thus forcing the air/fuel mixture into the cylinder 24 through the transfer port 28.

A speed sensor 38 is attached to the crankshaft 22. The speed sensor 38 is connected to a controller, such as an electronic control unit (ECU) 40, which together determine the speed of rotation of the crankshaft 22. The speed sensor 38 could be of the type that detects a marker upon the crankshaft with a stationary detector. If so, the detector sends a signal to the ECU 40 each time the marker passes the detector. In this manner, the ECU 40 detects the amount of time elapsed between the consecutive passing of the marker and, along with the distance between the markers, the ECU 40 calculates the speed of the crankshaft in revolutions per minute (RPM).

Also connected to the ECU 40 is a solenoid 42 disposed adjacent a carburetor 44 and an exhaust gas temperature sensor 46 disposed in an exhaust or tuned pipe 48. The tuned pipe 48 has a first end connected to the exhaust port 32 and a second end open to the atmosphere or to a muffler.

Referring again to FIG. 1, during operation of the engine 10, the air/fuel mixture enters the crankcase chamber 36 through the air/fuel inlet 30. During the compression stage, the piston 20 travels towards the spark plug 34 creating a vacuum in the crankcase chamber 36 that causes an air/fuel mixture to be sucked into the crankcase chamber 36 from the carburetor 44. During the power stroke of engine 10, when the piston 20 travels away from the spark plug 34, the piston 20 covers the exhaust port 32 and the transfer first opening 27 of the transfer port 28. The reed valve 37 prevents the air/fuel mixture from escaping from the crankcase chamber 36, thus increasing the pressure in the chamber 36. Once the piston 20 is below the first opening 27 of the transfer port 28, the pressurized gas in the crankcase chamber 36 is forced into the cylinder 24. Upon return of the piston 20 toward the spark plug 34, the transfer port 28 and the exhaust port 32 are again covered and the air/fuel mixture is compressed and ignited by the spark plug 34.

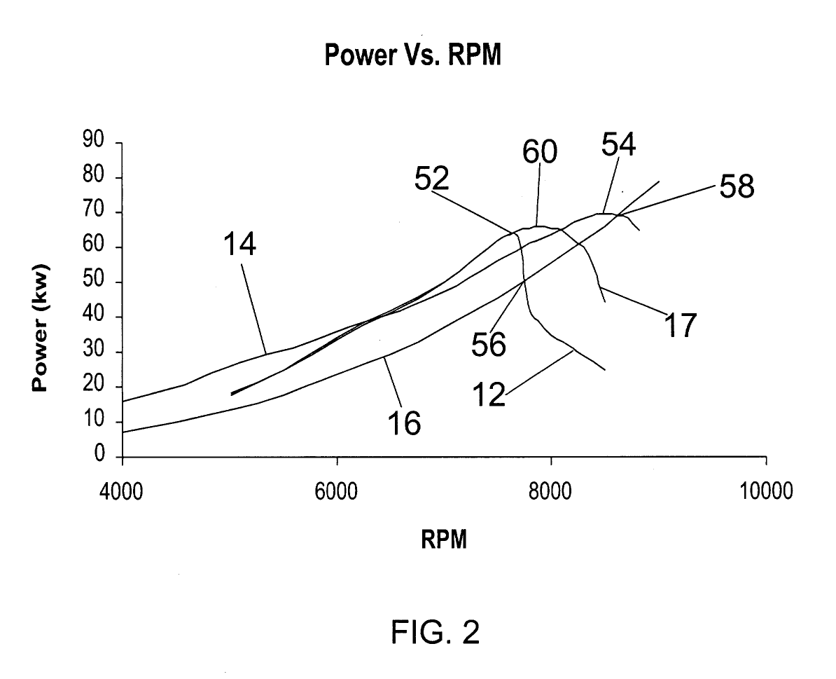

FIG. 2 illustrates two power curves 12 and 14. Curve 12 presents the power curve of an engine across a range of RPM while operating at a low tuned pipe temperature. Curve 14 presents the power curve of the engine across a range of RPM while operating at a high tuned pipe temperature. Points 52 and 54 represent the peak power output of the engine while operating at cold and hot tuned pipe temperatures respectively. As can be seen from curves 12 and 14, the peak power point 52 is located at a lower power and RPM level than that of peak power point 54.

Also shown in FIG. 2 is a clutch load line 16. The clutch load line 16 represents the maximum power output of the clutch, otherwise known as a continuous variable transmission (CVT). A CVT is calibrated to follow any particular curve, such as curve 16. A CVT comprises a movable flange connected to speed responsive element that urges the movable flange towards a fixed flange against a spring resistance. The speed responsive element is designed to act against the spring resistance with a force that increases with the rotational force experienced by the CVT. Levers attached to the movable flange react to the centrifugal forces created by the rotation of the fixed flange and apply axial forces between the fixed flange and moveable flange, causing the flanges to move closer together. Curve 16 intersects curves 12 and 14 at points 56 and 58 respectively. As can be seen, the intersection 58 is close to the maximum power output point 54 achievable along the curve 14.

It can be seen from the curve 12 that engine operation above the RPM corresponding to peak power output 52, has a pronounced slope where a slight change in RPM results in a significantly lower power output of the engine. This is a result of poor ETE beyond point 52. It is within this range of RPM operation, while operating at low tuned pipe temperatures, that causes problems for snow-cross racers at the beginning of a race. As can be seen from curve 14, the slope of curve 14 beyond the RPM corresponding to peak power output 54, is less than that of curve 12. Curve 14 is, therefore, the curve desired for operation of the engine in any situation since the peak power output is the highest and the slope of the curve at high RPM operation is lowest. This is because the engine parameters, such as the tuned pipe, the air/fuel ratio and clutching have all been calibrated to produce the engine's maximum power at a high exhaust or tuned pipe temperature operating at high engine RPM.

Engine operation along curve 14 is not obtained until the engine has been under high RPM operation for a sufficient amount of time to cause the hot exhaust gases to increase the temperature of the tuned pipe. Before the engine begins to operate with a power curve resembling that of curve 14, the engine will operate along power curves between that of power curve 12 and power curve 14.

Curve 17 represents the power vs. RPM curve of the present invention at a temperature similar to that of curve 12. As can be seen from FIG. 2, the peak power point 60 of curve 17 is higher than the peak power point 52 located on curve 12. The slope of curve 17 beyond peak power point 60 also has a lower slope compared to that of curve 12 in the same RPM operating range. Like curve 12, curve 17 is a power vs. RPM curve plotted shortly after start up of the engine. An increase in peak power and the lower slope was obtained by reducing the brake specific fuel consumption (BSFC) during high RPM operation of the engine. The BSFC is calculated by dividing the amount of fuel, in grams weight, supplied to the engine, by the power output of the engine.

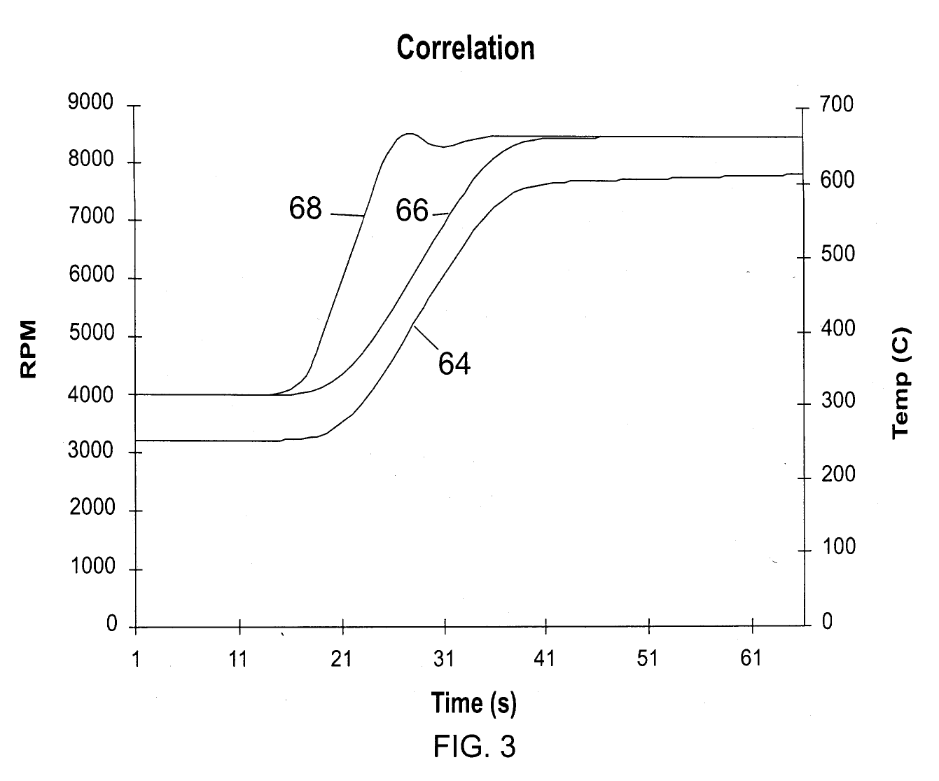

FIG. 3 illustrates the relationship between curves 64, 66, and 68 over a period of time while increasing the RPM of the engine. Curve 64 represents the exhaust gas temperature measured in the exhaust pipe using a temperature sensor. Curve 66 is a calculated MAES, and curve 68 is the actual RPM of the engine determined by a controller connected to the speed sensor. The MAES is calculated by using 100 consecutive engine speeds that are determined by the speed sensor located on a rotating shaft, such as the crankshaft. The first MAES point corresponds to the average speed of revolutions 1 through 100 of the crankshaft, the second MAES point corresponds to the average speed of revolutions 2 through 101 and the third corresponds to revolutions 3 through 102 and so on.

It has been discovered through experimentation by the inventor of the present invention that a curve of MAES corresponds very closely to a curve of exhaust gas or tuned pipe temperatures while the engine is experiencing a change in actual RPM such as that shown by curve 68. This enables a very accurate representation of the exhaust pipe temperature without having an additional temperature sensor located adjacent the exhaust pipe. While using a temperature sensor located in the tuned pipe may be sufficient, the use of the calculated MAES eliminates the risk of temperature sensor failure or influence of the temperature sensor from the surrounding environment.

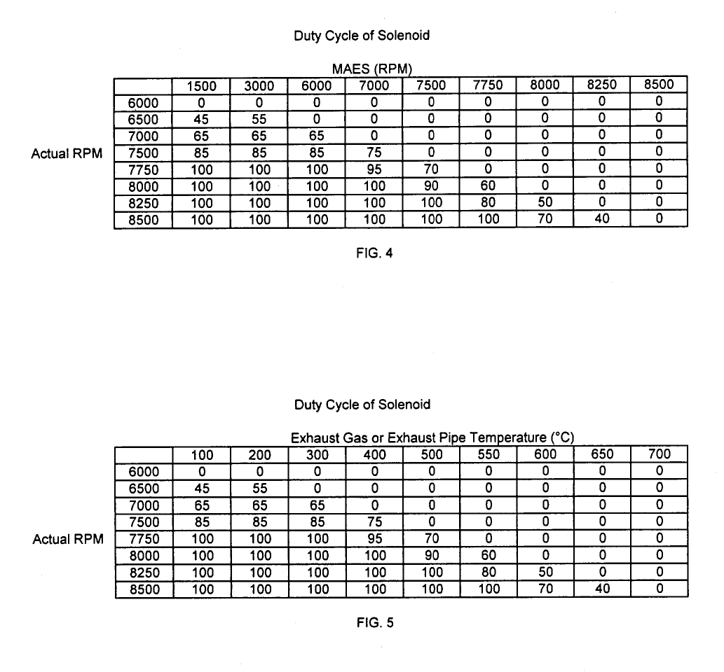

Upon receiving the actual RPM's from the speed sensor, the controller calculates the MAES and retrieves from a map, such as that shown in FIG. 4, the duty cycle of a solenoid. The solenoid is operated with a duty cycle such that the fuel flow into the crankcase chamber will decrease. This in turn will decrease the BSFC.

Alternatively, the controller receives the actual RPM from the speed sensor and the temperature of the exhaust or tuned pipe and retrieves from a map, such as that shown in FIG. 5, the duty cycle of a solenoid. The solenoid is then operated in the same manner as described above.

By altering the BSFC, the engine can operate at optimum ignition timing. Additionally, once the temperature in the exhaust pipe has reached a maximum, the controller will continue to ensure a BSFC that will obtain maximum engine power output. The solenoid may be activated with a duty cycle or in a partially open or partially closed state that will allow the correct amount of fuel to flow into the crankcase chamber.

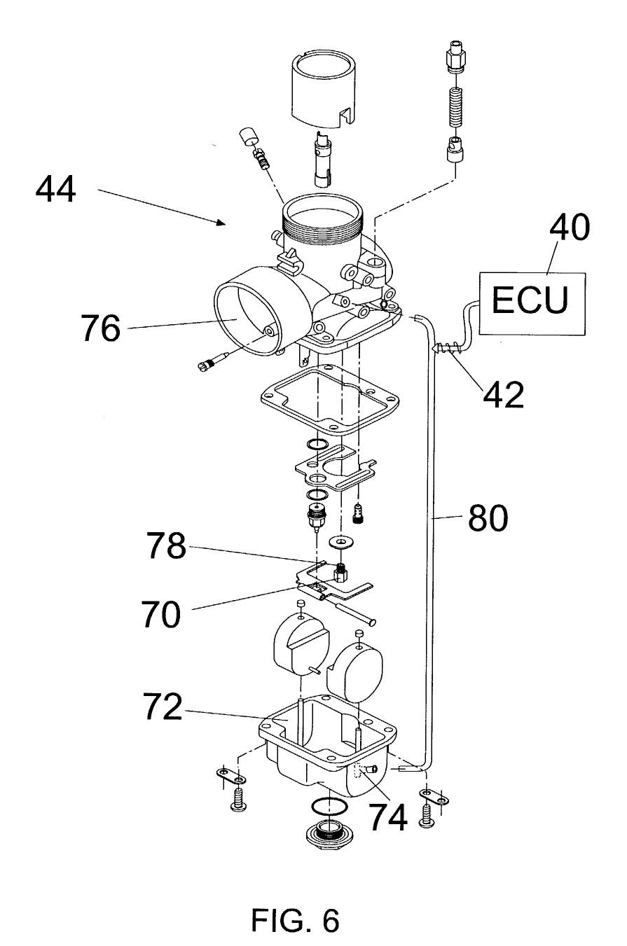

Referring to FIG. 6, the solenoid 42 may be located adjacent a carburetor 44. The carburetor 44 has a main jet 70 located in a float bowl 72 that is normally filled with fuel. The main jet 70 is connected to a conduit 78, which enables the fuel to flow into the air inlet 76 of the carburetor 44 and through the inlet 30 of the engine 10 to be ignited. A power jet 74 is also immersed in the float bowl 72. The power jet 74 is connected to a second conduit 80, which also allows fuel to flow from the float bowl 72 to the inlet 76 and then into the inlet 30 of the engine 10. As would be known by one skilled in the art, the carburetor 44 could be of any type. The solenoid 42 is disposed adjacent the second conduit 80 such that the flow of fuel through the second conduit 80 can be adjusted. The solenoid 42 is also connected to the ECU 40 such that upon retrieving a duty cycle from a map (such as that shown in FIGS. 4 or 5), the ECU 40 can control the solenoid 42 at the determined duty cycle.

The present invention may also be used with a semi-direct or direct injected fuel injection system. In many prior art fuel injection systems, a controller controls fuel injectors to inject a pre-calculated amount of fuel into the combustion chamber of the engine. With such fuel injection systems, there is no longer a need for a solenoid to adjust the amount of fuel. Instead, the controller calculates the MAES and is programmed to alter the amount of fuel injected to the engine by using the fuel injectors.

Yet another method of altering the fuel supply as a result of the calculated MAES is by using the DPM (Digital Performance Management) system found on Ski-Doo™ snowmobiles. This system alters the pressure found inside the float bowl of the carburetor, thus altering the pressure differential between the inside of the float bowl and that found downstream the carburetor. It is this pressure differential which pulls the fuel from the float bowl into the engine. With the DPM system, the controller would calculate the MAES and alter the pressure differential to ensure the engine is supplied with sufficient fuel to alter the BSFC to obtain the increase in power output needed at a particular engine RPM.

While the invention has been described in connection with what is presently considered to be the most practical and preferred embodiments, it is to be understood that the invention is not to be limited to the disclosed embodiments and elements, but, to the contrary, is intended to cover various modifications, combinations of features, equivalent arrangements, and equivalent elements included within the scope of the appended claims. Furthermore, the dimensions of features of various components provided are not meant to be limiting, and the size of the components can vary from the size that is portrayed in the figures and table herein in order to accommodate differently sized engines.

What is claimed is:

1. A two-cycle engine, comprising:
a cylinder;
a piston moveable in the cylinder for compressing an air/fuel mixture to be ignited in the cylinder;
a first sensor for detecting an engine speed;
a fuel source supplying fuel to the engine; and
a controller for controlling at least one of the first sensor and the fuel source;
wherein the controller determines a moving average engine speed corresponding to an average of at least two detected engine speeds.

2. The engine of claim 1, wherein the controller further controls an amount of fuel supplied from the fuel source to the engine as a function of the engine speed detected by the first sensor and the moving average engine speed.

3. The engine of claim 2, wherein the controller further comprises at least one map, the at least one map containing a relationship between the engine speed, the moving average engine speed and the amount of fuel supplied to the engine.

4. The engine of claim 3, wherein an output of the at least one map is a solenoid duty cycle that controls the amount of fuel supplied to the engine as a function of the engine speed and the moving average engine speed.

5. The engine of claim 4, wherein the solenoid is disposed adjacent to the fuel source.

6. The engine of claim 5, wherein the amount of fuel supplied to the engine is altered by the solenoid, which is controlled by the controller.

7. A method of operating an engine, comprising:
determining an engine speed;
determining a moving average engine speed; and
determining an amount of fuel to be supplied to the engine corresponding to the engine speed and the moving average engine speed.

8. The method of claim 7, wherein the moving average engine speed is determined by an average of at least two engine speeds.

9. The method of claim 8, wherein determining the amount of fuel to be supplied to the engine further comprises determining the duty cycle of a solenoid from a map corresponding to the engine speed and the moving average engine speed.

10. The method of claim 9, wherein the engine speed is determined with the assistance of a sensor disposed near a rotating shaft of the engine and the moving average engine speed is determined by a controller connected to the engine.

11. A two-cycle engine, comprising:
a cylinder;
a piston moveable in the cylinder for compressing a fuel-air mixture to be ignited in the cylinder;
a first sensor for detecting an engine speed;
a second sensor for detecting a temperature;
a fuel source for supplying fuel to the engine; and
a controller that controls an amount of fuel flowing from the fuel source to the engine as a function of the engine speed detected by the first sensor and the temperature detected by the second sensor.

12. The engine of claim 11, wherein the controller further comprises:
at least one map comprising a relationship between the engine speed and the detected temperature.

13. The engine of claim 12, further comprising an exhaust pipe, wherein the second sensor is disposed adjacent to the exhaust pipe.

14. The engine of claim 13, wherein the first sensor is disposed adjacent a rotating shaft of the engine.

15. The engine of claim 14, further comprising a solenoid connected to the fuel supply, the solenoid being controlled by the controller.

16. The engine of claim 15, wherein the controller is an electronic control unit.

17. The engine of claim 16, wherein the at least one map further comprises a relationship with the solenoid operation.

18. The engine of claim 17, wherein the solenoid operation is obtained from the map as a function of the engine speed and the exhaust gas temperature.

19. A method of operating an engine, comprising:
determining an engine speed;
determining one of an exhaust gas temperature and an exhaust pipe temperature; and
controlling an amount of fuel flow into the engine according to the determined engine speed and at least one of the exhaust gas temperature and the exhaust pipe temperature.

20. The method of claim 19, wherein the engine speed is determined by a sensor disposed adjacent to a rotating shaft of the engine, the temperature is determined by a sensor disposed adjacent to an exhaust pipe, and the amount of fuel flow is controlled by a solenoid.

21. The method of claim 19, wherein the engine speed is determined by a sensor disposed adjacent to a rotating shaft of the engine, the temperature is determined by a sensor disposed adjacent to an exhaust pipe, and the amount of fuel flow is controlled by an electronic fuel injection system.

22. The method of claim 20, wherein controlling the amount of fuel flow further comprises obtaining the operation of the solenoid from a map of the determined engine speed and at least one of the determined exhaust gas temperature and the determined exhaust pipe temperature.
